(19) United States
(12) Patent Application Publication
(10) Pub. No.: US 2025/0390732 A1
(43) Pub. Date: Dec. 25, 2025

(54) AXICONAL PHOTONIC NEURAL NETWORK

(71) Applicant: Mayur Popuri, Hoffman Estates, IL (US)

(72) Inventor: Mayur Popuri, Hoffman Estates, IL (US)

(21) Appl. No.: 18/750,656

(22) Filed: Jun. 21, 2024

(51) Int. Cl. G06N 3/067; G06N 3/08

(52) U.S. Cl. CPC G06N 3/067; G06N 3/08

(57) ABSTRACT

An axiconal photonic neural network is provided. The axiconal photonic neural network can include interconnected axiconal neurons to produce a classification using laser light. A first axiconal neuron of the interconnected axiconal neurons can include a material to non-linearly interact with the laser light, the material including a thickness determined with a machine learning technique. The first axiconal neuron can include an axicon to receive the laser light from the material and produce a ring profile. The axiconal photonic neural network can include a waveguide positioned at the ring profile to guide the laser light of the ring profile to a second axiconal neuron of the interconnected axiconal neurons.

### BACKGROUND

Optical computing or photonic computing is a technology that uses light to perform computations. For example, fields such as silicon photonics use silicon based optical media to process information.

### SUMMARY

At least one aspect of the present disclosure is directed to a photonic neural network apparatus. The photonic neural network apparatus can include interconnected axiconal neurons to produce a classification using laser light. A first axiconal neuron of the interconnected axiconal neurons can include a material to non-linearly interact with the laser light, the material including a thickness determined with a machine learning technique and an axicon to receive the laser light from the material and produce a ring profile. The photonic neural network apparatus can include a waveguide positioned at the ring profile to guide the laser light of the ring profile to a second axiconal neuron of the interconnected axiconal neurons.

The interconnected axiconal neurons can each include a material to non-linearly interact with the laser light, the material of each of the interconnected axiconal neurons including a thickness determined with the machine learning technique to provide an attention mechanism.

The material to non-linearly interact with the laser light can cause the axicon to generate the ring profile including a thickness between an inner and outer radius of the ring profile, the thickness non-linearly related to an intensity of the laser light received by the material.

The waveguide can include an input positioned a distance in a transverse direction from the ring profile, the distance determined with the machine learning technique.

The photonic neural network apparatus can include a first layer of axiconal neurons of the interconnected axiconal neurons, the first layer of axiconal neurons including the first axiconal neuron. The photonic neural network apparatus can include a second layer of axiconal neurons of the interconnected axiconal neurons. The photonic neural network apparatus can include waveguides positioned at the ring profile of the first axiconal neuron to guide the laser light to an input of each of the interconnected axiconal neurons of the second layer of axiconal neurons to form a dense network.

The thickness of the material for the first axiconal neuron can be determined with the machine learning technique using real numbers and not imaginary numbers.

The photonic neural network apparatus can include a coupler to receive the laser light output from at least two of the interconnected axiconal neurons, combine the laser light output from the at least two of the interconnected axiconal neurons, and provide the combined laser light to an input of the first axiconal neuron.

The photonic neural network apparatus can include a pulsed laser to generate the laser light, the pulsed laser having a power level on an order of gigawatts or higher. The photonic neural network can include a coupler to receive the laser light from the pulsed laser and fan the laser light into waveguides. The photonic neural network apparatus can include an electrical attenuator to attenuate the laser light guided by at least some of the waveguides to encode input data with the laser light for the interconnected axiconal neurons to generate the classification with.

The photonic neural network apparatus can include a final layer of axiconal neurons of the interconnected axiconal neurons. The photonic neural network apparatus can include waveguides to connect each axiconal neuron of the final layer of axiconal neurons with one electrical detector of a set of electrical detectors. The photonic neural network apparatus can include the set of electrical detectors to generate an electrical signal to indicate the classification.

The photonic neural network apparatus can include a motor to switch the material with a second material, the motor to move the material out of a path of propagation of the laser light and move the second material into the path of propagation of the laser light. The second material can non-linearly interact with the laser light, the second material can include a second thickness different than the first thickness.

The photonic neural network apparatus can include a motor to move the waveguide to vary a distance in the transverse direction between an input of the waveguide and the ring profile.

At least one aspect of the present disclosure is directed to a method. The method can include receiving parameters of a neural network trained with a machine learning technique. The method can include selecting, using the parameters, materials to non-linearly interact with laser light, the materials including different thicknesses. The method can include coupling the materials with axicons to form axiconal neurons, the axicons to receive the laser light from respective materials of the materials and produce ring profiles. The method can include providing waveguides to guide the laser light from ring profiles of first axiconal neurons of the axiconal neurons to inputs of second axiconal neurons of the axiconal neurons.

The method can include determining, by a computing system, the different thicknesses with the machine learning technique to provide an attention mechanism for the axiconal neurons.

The method can include positioning, using the parameters, inputs of the waveguides different distances in a transverse direction from the ring profiles.

The method can include receiving an electrical signal indicating input data. The method can include operating a pulsed laser to generate the laser light at a power level on an order of gigawatts or higher. The method can include receiving, by a coupler, the laser light from the pulsed laser. The method can include fanning, by the coupler, the laser light into particular waveguides. The method can include attenuating, using an electrical attenuator and the electrical signal, the laser light guided by at least some of the particular waveguides to encode the input data.

The method can include detecting, using a set of electrical detectors, an intensity of the laser light output by a final layer of the axiconal neurons. The method can include generating, using the set of electrical detectors, an electrical signal indicating a classification.

The method can include operating a motor to switch a first material with a second material, the motor to move the first material out of a path of propagation of the laser light and move the second material into the path of propagation of the laser light. The second material can non-linearly interact with the laser light, the second material can include a second thickness different than a first thickness of the first material.

The method can include operating a motor to move a waveguide in a traverse direction to vary a distance in the transverse direction between an input of the waveguide and a ring profile.

At least one aspect of the present disclosure is directed to an axiconal neuron apparatus. The axiconal neuron apparatus can include a material to non-linearly interact with laser light, the material including a thickness determined with a machine learning technique. The axiconal neuron apparatus can include an axicon to receive the laser light from the material and produce a ring profile. The axicon can provide the ring profile to a waveguide to guide the laser light of the ring profile to another axiconal neuron apparatus.

The axiconal neuron apparatus can include the material to non-linearly interact with the laser light to cause the axicon to generate the ring profile including a thickness between an inner and outer radius of the ring profile, the thickness non-linearly related to an intensity of the laser light received by the material.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an example axiconal neuron of an axiconal photonic neural network.

FIG. 2 is an example gaussian distribution of a laser light input to an axiconal neuron of an axiconal photonic neural network.

FIG. 3 is an example low intensity ring profile distribution of laser light output by an axicon of an axiconal neuron of an axiconal photonic neural network.

FIG. 4 is an example high intensity ring profile distribution of laser light output by an axicon of an axiconal neuron of an axiconal photonic neural network.

FIG. 5 is an example view of a ring profile of laser light and inputs of waveguides to carry the laser light to subsequent axiconal neurons of an axiconal photonic neural network.

FIG. 6 is an example system including of an axiconal photonic neural network and a computing system to provide an input signal for the network and receive a classification signal from the network.

FIG. 7 is an example system including a computing system to train parameters for an axiconal photonic neural network and a manufacturing system to construct the axiconal photonic neural network according to the parameters.

FIG. 8 is an example method of constructing an axiconal photonic neural network according to trained parameters.

FIG. 9 is an example method of executing an axiconal photonic neural network.

FIG. 10 is an example computing architecture of a computing system.

### DETAILED DESCRIPTION

Following below are more detailed descriptions of various concepts related to, and implementations of, methods, apparatuses, and systems of an axiconal photonic neural network. The various concepts introduced above and discussed in greater detail below may be implemented in any of numerous ways.

An artificial neural network can be a model that mimics the human brain structure by including multiple neurons. In an artificial neural network, each neuron can weight inputs received from other neuron outputs, sum the weighted inputs, and apply a bias to the sum. Furthermore, the neuron can pass the biased sum through an activation function, before providing the output of the neuron to subsequent neurons in the network. A machine learning technique, such as gradient descent, can compute an error for a network using a training dataset and a loss function. Through backpropagation, the machine learning technique can learn values for the neuron weights, biases, and interconnections. Neural networks can scale to large sizes, with some network having millions or even billions of weights. Executing a neural network to generate an inference on electrical silicon or transistor based hardware, such as a graphics processing unit (GPU), a neural processing unit (NPU), or other semiconductor chip, can be slow, and consume large amounts of processing power due to the millions or billions of calculations needed to perform a single pass of the neural network.

Some solutions to electrical silicon based neural network hardware include optical or photonic neural networks. An optical or photonic neural network can process information at the speed of light, and a single pass of even a large model can take only the length of time for light to propagate from the input of an apparatus implementing the model to the output. Furthermore, the optical or photonic neural network can be significantly more power efficient than electrical silicon based hardware, which can lose power due to heat. However, conventional optical or photonic neural networks can be difficult to train computationally. In some cases, an optical or photonic neural network can encode information on optical components with a coating of a particular refractive index selected through training and applied to the aperture of the optical component. However, determining the proper refractive indexes through training can be computationally difficult and power intensive, given that complex numbers may need to be used to account for both magnitude and phase of light. These inefficiencies and inaccuracies in training can lead to less accurate optical or photonic networks. Furthermore, these refractive based approaches can result in high light intensity or power losses in the network. This prevents the network from having one neuron connect to many other neurons, in some cases, restricting the network to fewer neurons with fewer neural connections. This again can lead to inaccurate classifications by the network. Furthermore, conventional photonic or optical neural networks may not have any mechanism to implement attention in the network to ensure that important information is carried forward to subsequent layers of the neural network, while less important information is not.

To solve for these, and other technical issues, the technical solutions disclosed herein can include an axiconal photonic neural network. The axiconal photonic neural network can include layers of neurons, each including an axicon. An axicon can be a lens with a conical (e.g., cone shaped) surface. The axicon can produce a Bessel beam within a Bessel region from the conical surface, and a ring profile outside the Bessel region. The ring profile can be a ring-shaped light intensity distribution. The ring profile can be ring-shaped or annular shaped. Light can be most intense in a center band of the ring, and less intense away from the center band. By using an axicon to produce a ring profile, multiple waveguides can be positioned around the ring-profile in a transverse direction compared to the direction that light travels through the network. Because the highest light intensity can be in the middle band of the ring, waveguides can be positioned around the ring in order to carry the light to inputs of multiple other neurons in subsequent layers of the network. In view of the low light intensity losses of the axicon and the ability to surround the ring profile with multiple waveguides, light can be carried to a high number of neurons, e.g., hundreds, thousands, millions. Thus, a dense neural network can be constructed from the axiconal neurons.

Furthermore, each axiconal neuron can include a material positioned in front of an aperture of the axicon that non-linearly interacts with light. For example, the material can provide second or third order non-linear polarization of light, and can have a nonlinear refractive index, n₂. The material can be sapphire, yttrium aluminum garnet, yttrium vanadate, etc. The material can have a non-linear relationship between light intensity input at the material and the refractive index of the material. Because the input light source of the photonic neural network can be high, e.g., on the order of gigawatts, terawatts, or petawatts, the material can exhibit second or third order non-linear polarization of light. The thickness of the material in the direction of propagation of light can change the intensity of light in the ring profile produced by the axicon. There can be a non-linear relationship between this thickness of the material and the intensity of the light in the ring profile. Therefore, the material can provide a non-linear effect in the network, that allows for important information (e.g., high intensity light) to propagate to subsequent neurons in the network, but prevents less important information (e.g., low intensity light) from propagating in the network. This non-linear relationship can provide an attention mechanism in the network that can be trained.

Regarding training, a computing system can execute a machine learning technique to determine characteristics for each axicon of the network to encode trained parameters of the network. For example, the machine learning technique can optimize a distance between each waveguide input and the ring profile. Furthermore, the machine learning technique can optimize the thickness of each material positioned in front of the apertures of the axicons. The distance and the thickness can encode parameters of the training, and thus configure the network to solve a particular classification task. In some implementations, responsive to receiving a set of parameters for a network, a corresponding photonic network with material thicknesses and waveguide distances can be constructed, configured, or manufactured, thus providing a physical optical neural network apparatus constructed to run inferences for a specific trained model. Determining the thicknesses and distances can be done using real numbers, R. In contrast to other techniques, which may use complex numbers, i, to account for magnitude and phase of light, the axiconal neural network can be trained with real numbers R, and thus result if faster computer training and more efficient computer training (e.g., using less memory, processing resources, and power), in addition to resulting in more accurate photonic networks.

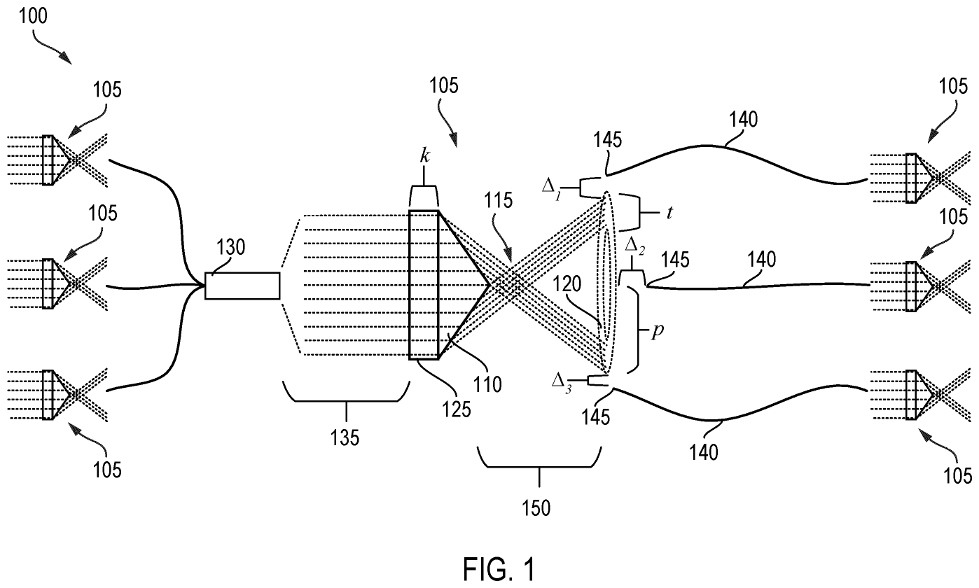

Referring now to FIG. 1, among others, an example axiconal neuron 105 of an axiconal photonic neural network 100 is shown. The network 100 can be an apparatus, system, or device. The network 100 can be an optical or photonic apparatus. The apparatus 100 can be an artificial neural network. The apparatus 100 can be an optical or photonic artificial neural network. The apparatus 100 may be a physical optical network. For example, the apparatus 100 can optically implement execution or inference of a neural network with light.

The network 100 can include at least one axiconal neuron 105. The axiconal neuron 105 can be an apparatus, a system, or a device. The neuron 105 can be an artificial neuron of an artificial neural network. The neuron 105 can be an optical or photonic device, apparatus, or system. The network 100 can include multiple axiconal neurons 105 that are interconnected, where light output by one neuron is input into another neuron. The network 100 can include at least one layer of axiconal neurons. For example, the network 100 can include multiple interconnected layers of axiconal neurons 100.

The axiconal neuron 105 can include at least one axicon 110. The axicon 110 can be a lens, an optical component, an apparatus, or a device. The axicon can be a conical lens or a rotationally symmetric prism. The axicon 110 can have a conical surface, e.g., a cone. In some implementations, the optical component 110 can be a parabolic axicon lens, an annular aperture, a conical lens, or an annular lens, etc. The optical component 110 can be any optical component or device that produces a ring profile 120. The axicon 110 can be made from silica, sapphire, plastic, or another material. The axicon 110 can, in some implementations, include a cylindrical base with a cylindrical shaped aperture to receive light, and a conical portion opposite the aperture with a conical surface to output light. The axicon 110 can receive light (e.g., laser light) and produce a ring profile 120 using the laser light. The axicon 110 can receive light at an input surface or aperture, and output light via the face of the conical surface of the axicon 110. The axicon 110 can have a Bessel region 115 a distance from the surface of the conical surface of the axicon 110. Past the Bessel region, the axicon 110 can produce a donut or ring profile 120. The ring profile 120 of light can have its highest intensity between an inner and outer circumference of the ring. For example, a band of light with a circumference between the inner and outer circumferences can have a highest light intensity, and the light intensity can decrease in both directions from the band to the inner circumference and the outer circumference. The axicon 110 can output light a distance 150 through free space to inputs 145 of waveguides 140. The distance 150 can be on the order of micrometers or hundreds of nanometers. The distance 150 can be much longer in some implements, and can be on the order of millimeters or centimeters.

The axiconal neuron 105 can include at least one material 125. The material 125 can be a lens, an optical component, an apparatus, or a device. In some implementations, the axiconal neuron 105 may not include the material 125. The material 125 can be a material that non-linearly interacts with light or laser light. For example, at high light intensities (e.g., light generated from gigawatt, terawatt, or petawatt lasers), the material 125 can provide second order or third order non-linear polarization of light. The material 125 can cause at least second order polarization or a higher order polarization. The material 125 can be silicon, fused silica, sapphire, yttrium aluminum garnet, yttrium vanadate, etc. The material 125 can be a non-linear crystal material with a non-centrosymmetric crystal structure. The material 125 can have a non-linear relationship between light intensity input at the material 125 and the refractive index of the material. The material 125 can have a non-linear index of at least 2.00 10⁻²⁰ m²/W. For example, fused silica can have a non-linear index of 2.19 10⁻²⁰ m²/W at 1030 nm, sapphire can have a non-linear index of 2.8 10⁻²⁰ m²/W at 1550 nm, yttrium aluminum garnet can have a non-linear index of 6.13 10⁻²⁰ m²/W at 103 nm. The non-linear index of the material 125 can be higher than that of the axicon 110. The non-linear index of the material 125 can be equal to or less than the non-linear index of the axicon 110.

The thicknesses k of the materials 125 of the axicons 110 can vary. In this regard, having different thicknesses k materials 125 at different axicons 110 can ensure variability between the axicons 110, and thus trainability of the network 100. The thickness k of the material 125 of each axiconal neuron 105 can be unique, and optimized digitally using a computing system. For example, the thickness k of the materials 125 can be trained with a machine learning technique.

The material 125 can be cylindrical or disc shaped. The material 125 can be coupled with the axicon 110. The material 125 can be deposited, positioned, or fixed at or on a face or aperture of the axicon 110. For example, coupling the material 125 with the axicon 110 can include disposing or positioning the material 125 in front of, at, or against, the axicon 110. The material 125 can be disposed or positioned between an output of a coupler 130 and an input or aperture of the axicon 110. In some implementations, the axicon 110 includes a cylindrical shaped based, and the material 125 is positioned in front of the aperture of the cylindrical shaped base. In some implementations, the axicon 110 does not include a cylindrical shape base, and the material 125 is positioned in front of an aperture of the axicon cone.

The network 100 can include at least one waveguide 140. The network 100 can include various waveguides 140 to guide light from the ring profile 120 to inputs of axiconal neurons 105 of a subsequent layer of the network 100. The waveguide 140 can be positioned at the ring profile 120 to guide light (e.g., laser light) of the ring profile 120 to a second or subsequent axiconal neuron of the interconnected axiconal neurons 105. The waveguides 140 can be fiber optic cables. The waveguides 140 can be plastic or glass waveguides. The waveguides 140 can be planar waveguides (e.g., slab waveguides), two-dimensional waveguides (e.g., rectangular waveguides), light pipes, light tubes, or optical fibers. The waveguides 140 can include materials of varied refractive indices to guide light in a desired direction or within a desired region. For example, the waveguides 140 can include a core and cladding at least partially surrounding the core. In some implementations, the network 100 can include a waveguide 140 to carry light to inputs of each of the axiconal neurons 105 of a subsequent layer of the network 100. An end or input 145 of each waveguide 140 can be open to receive light of the ring profile 120 and guide light to inputs of subsequent axiconal neurons 105. The input of an axiconal neuron 105 can be an input to the coupler 130 or the aperture of the material 125. The output of the axiconal neuron 105 can be the face of the axicon 110, or the region where the ring profile 120 is produced.

In some implementations, each input 145 can be positioned a different distance from a center of the ring profile 120. For example, each input 145 can be positioned a distance in a traverse or perpendicular direction from the direction of propagation of light. The inputs 145 can be positioned difference distances from a center band or highest intensity band of the ring profile 120. In some implementations, the inputs 145 are located different distances from a longitudinal axis of the axicon 110. Each distance between the inputs 145 of the waveguides 140 and the ring profile 220 can be different or the same, e.g., Δ₁ . . . Δₙ. Each distance can be determined and set via a machine learning technique. Similarly, the thickness, k, of the material 125 can be determined and set via the machine learning technique. All of the distances Δ₁ . . . Δₙ and thicknesses k of each axiconal neuron 105 can be parameterized digitally in an artificial neural network and trained by at least one computing system. The computing system can use a training dataset to perform backpropagation and gradient descent to determine optimal values for each distance Δ₁ . . . Δₙ and thicknesses k of each axiconal neuron 105. The computing system can run through multiple epochs of training cycles, in some implementations. In this regard, the network 100 can be built, constructed, or configured to have the distances Δ₁ . . . Δₙ and thicknesses k indicated by running training by the computing system. In some implementations, the machine learning technique can be any supervised learning technique.

The values for Δ₁ . . . Δₙ and for k can act as parameters for the network 100 that can be optimized. Each interconnecting waveguide 140 can sit at an offset of Δ from the peak intensity radius p. This can allows for per-pairwise-transmission differential sensitivity to input intensity from a neuron 105 to each successor neuron 105. The parameters Δ₁ . . . Δₙ and k can be unique for each axiconal neuron 105 of the network 100, and can be the same as or equivalent to model weights of a digital neural network. The thickness parameter k can allow stronger beams to narrow more than weaker beams, with the thickness k of the layer of material 125 being non-linearly proportional to the width reduction per unit intensity of the light beam. This can allow for a per-neuron differential sensitivity to input light intensity. Both parameters Δ₁ . . . Δₙ and k can allow for a robust, nonlinear, and computationally feasible trainable encoding breadth.

The axicon 110 can include at least one coupler 130. The coupler 130 can receive light via at least one waveguide from at least one axicon 110 of a previous layer (or from an input from a laser). For example, the coupler 130 can receive light from at least one, two, three, or any number of axiconal neurons 105. The coupler 130 can combine the received light from multiple axicons 110 of a previous layer. In some implementations the coupler 130 can combine light from every axicon 110 in a previous layer of the network 100. The coupler can provide the combined light to the material 125. The output of the coupler 130 and the input of the material 125 can be separated by free space. The separation between the output of the coupler 130 and the material 125 can be a distance 135. The distance 135 can be the order of nanometers or micrometers. Light can propagation from the output of the coupler 130 to the input of the material 125 with a Gaussian profile, in some implementations.

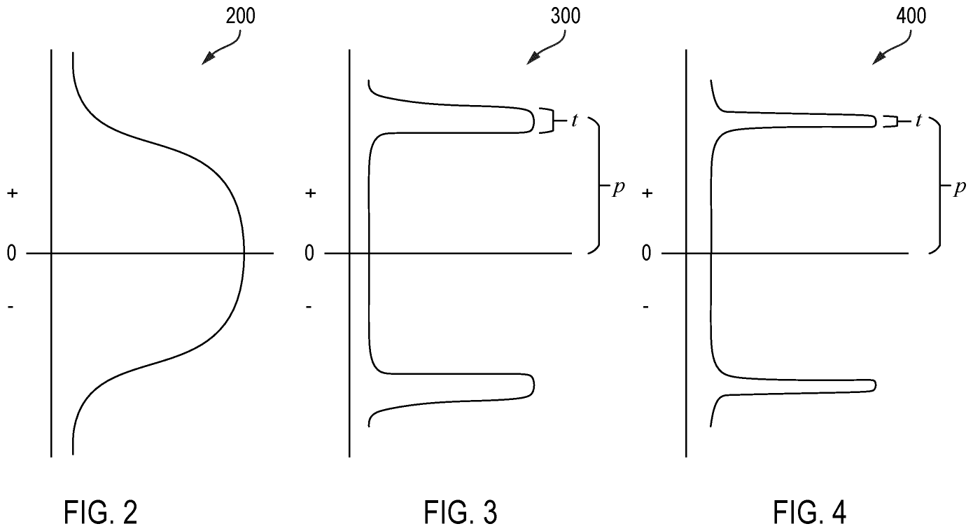

Referring now to FIG. 2, among others, an example gaussian distribution 200 of a laser light input to an axiconal neuron 105 of an axiconal photonic neural network 100 is shown. The beam of light input into the aperture of the axicon 110 can be a gaussian beam according to the example gaussian distribution 200 where the transverse intensity profile follows the gaussian distribution 200. The gaussian beam can have a beam waist that is the same as, or less than, the diameter of the aperture or mouth of the axicon 110. In some implementations, the beam waist has a diameter greater than the aperture or mouth of the axicon 110. The intensity of the Gaussian beam waste can be/=1/e². In some implementations, the axiconal neural network 100 can include at least one lens to adjust or change the beam waist of the Gaussian beam such that it is less than the diameter of the aperture of mouth of the axicon 110. For example, the axiconal neural network 100 can include at least one biconvex (converging) or biconcave (diverging) lens positioned or disposed between the output of the coupler 130 and the input of the axicon 110.

Referring now to FIGS. 3-4, example ring profile distributions 300 and 400 of laser light output by an axicon 110 of an axiconal neuron 105 of an axiconal photonic neural network 100 is shown. FIG. 3 illustrates an example low intensity ring profile distribution 300, while FIG. 4 illustrates an example high intensity ring profile distribution 400. Both distributions 300 and 400 illustrate how intensity is distributed as a beam traverses through the axicon 110. Each axiconal neuron 105 can accept a Gaussian beam (e.g., the example Gaussian distribution as shown in FIG. 2) at its input, and emit a ring profile intensity distribution with a radius p and thickness t. The distributions 300 and 400 can indicate light intensity in a transverse plane relative to the direction of travel of light (e.g., light traveling left to ring in FIGS. 3-4).

As can be seen in FIGS. 3 and 4, the radius p remains constant (or substantially constant) with respect to intensity. For example, the radius p of the distribution in the low intensity distribution 300 is the same as the radius of the high intensity distribution 400. However, the width or thickness t of the peaks or hills of the distributions 300 and 400 change inversely with respect to intensity. The higher the intensity of the beam, the smaller the thickness t. As seen in FIG. 4, the distribution 400 has a thickness t less than a thickness t of the distribution 300 of FIG. 3, thus indicating that the intensity of light in the distribution 400 is greater than the intensity of light in the distribution 300.

The non-linear interaction (e.g., second or third order polarization of light) of the material 125 can create a non-linear relationship between the intensity of light input to the axicon and the resulting thickness t. For example, for a given intensity of light input to the axicon 110, there can be a non-linear relationship between the thickness k of the material 125 and the thickness t of the resulting ring profile 120. For example, the material 125 can non-linearly interact with laser light to cause the axicon 110 to generate the ring profile 120 including a thickness t between an inner and outer radius of the ring profile 120, the thickness t non-linearly related to an intensity of the laser light received by the material 125.

In this regard, the material 125 can encode a non-linear relationship in the axiconal neuron 105. With multiple axiconal neurons 105 each including a material 125, an attention mechanism can be encoded or provided within the network 100. The attention mechanism can cause important information (e.g., represented by high intensity light) to propagate to subsequent neurons 105 of the network 100, but less important information (e.g., represented by low intensity light) to be non-linearly diminished or suppressed such that the information does not propagate forward to subsequent neurons 105. The attention mechanism can be trained and implemented in the network 100 through the various thicknesses k set by the network training.

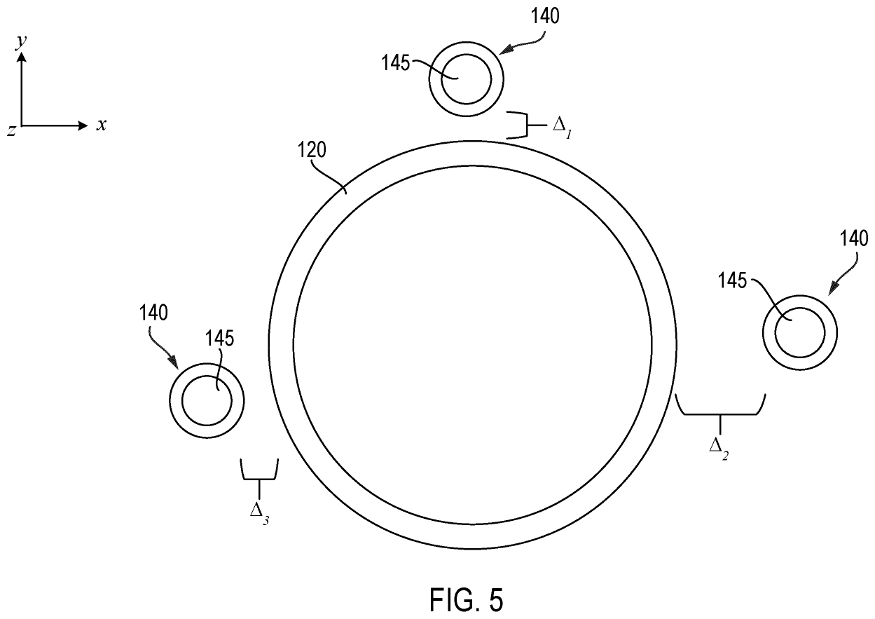

Referring now to FIG. 5, among others, a ring profile 120 of laser light and inputs of waveguides 140 to carry the laser light to subsequent axiconal neurons 105 of an axiconal photonic neural network 100 is shown. FIG. 5 illustrates a cross-section view looking in the direction that light travels from the axicon 110 to the waveguides 140. The ends 145 of the waveguides 140 can be separated by a distances Δ₁, Δ₂, Δ₃ from the highest intensity or a band of highest intensity of the ring profile 120. In FIG. 5, the ring profile 120 generated by an axiconal neuron 105 is provided to three subsequent axiconal neurons 105 of a succeeding layer via the three waveguides 140.

An end 145 of a first waveguide 140 is separated by a distance Δ₁ from the ring profile 120 in a transverse direction (e.g., in the x and/or y directions). The first waveguide 140 can guide light to a first axiconal neuron 105 of a subsequent or next layer of the axiconal photonic neural network 100. An end 145 of a second waveguide 140 is separated by a distance 42 from the ring profile 120 in a transverse direction (e.g., in the x and/or y directions). The second waveguide 140 can guide light to a second axiconal neuron 105 of a subsequent or next layer of the axiconal photonic neural network 100. An end 145 of a third waveguide 140 is separated by a distance Δ₃ from the ring profile 120 in a transverse direction (e.g., in the x and/or y directions). The third waveguide 140 can guide light to a third axiconal neuron 105 of a subsequent or next layer of the axiconal photonic neural network 100. Although three waveguides 140 are shown in FIG. 3, any number of waveguides 140 can be disposed around the ring profile 120.

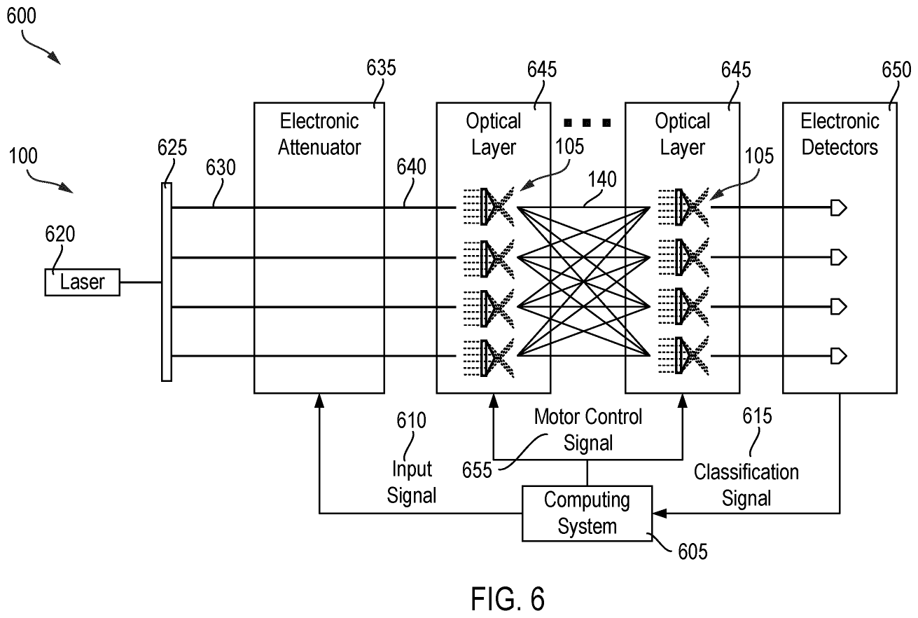

Referring now to FIG. 6, among others, an example system 600 including of an axiconal photonic neural network 100 and a computing system 605 that provides an input signal 610 for the network 100 and receives a classification signal 615 from the network is shown. The network 100 can include at least one laser 620. The laser 620 can produce or generate laser light to propagate through the network 100 from an input of the network 100 to an output of the network 100. The laser 620 can be a pulsed laser that generates laser light at a period, e.g., a 10 Hz period, a 9-11 Hz period, a period greater than 11 Hz, a period less than 9 Hz. The laser 620 can, at the interval, generate a high intensity laser input for a duration of time.

The laser power of the laser 620 can be on the order of gigawatts, terawatts, or petawatts. The laser 620 can generate laser light of a visible or non-visible spectrum. For example, the laser 620 can be a titanium-sapphire laser (i.e., a TI: sapphire or Ti: Al₂O₃ laser) with a wavelength between 514-532 nm. The laser 620 can be, or can be pumped with, another laser, such as an Nd: YAG laser (i.e., neodymium-doped yttrium aluminum garnet laser or Nd: Y₃Al₅O₁₂ laser) or an Er: YAG laser (i.e., erbium-doped yttrium aluminum garnet laser or erbium YAG laser). In some implementations, to increase the non-linear effects of the material 125, the laser 620 can be a mode-locking laser, such as a sapphire based laser, e.g., a TI: sapphire laser. The duration of each pulse can be short, on the order of picoseconds or femtosecond. With each pulse of the laser 620, a full pass of the network 100 can be performed.

The laser light produced by the laser 620 can be provided to at least one coupler 625. The coupler 625 can include at least one input, and multiple outputs. The coupler 625 can receive light via free space from the laser 620 or via an input waveguide. The coupler 625 can fan the input laser light into multiple outputs or multiple waveguides 630 (e.g., waveguides coupled with the outputs of the coupler 625). The waveguides 630 can be similar to or the same as the waveguides 140, e.g., fiber optic cables. For example multiple waveguides 630 can be connected to an output of the coupler 625, and carry the laser light 620 out of the coupler 625 to an electronic attenuator 635.

The electronic attenuator 635 can attenuate the laser light guided by at least one of the waveguides 630. In some implementations, the electronic attenuator 635 can attenuate or not attenuate light guided by each waveguide of the waveguides 630. The electronic attenuator 635 can attenuate light by a particular amount of particular level, e.g., between zero or no attenuation and full or complete attenuation, to encode an input signal 610 in the laser light guided by the waveguides 630. The electronic attenuator 635 can be electrically controlled by the computing system 605 to encode the input signal 610 in the laser light to be input into the optical layers 645 of the axiconal network 100 to process the input signal 610 and produce or generate a classification with. The attenuation can reduce power or intensity of light carried by each waveguide 630. The attenuated light can be output by the electronic attenuator 635 into an output waveguide 640. Each input waveguide 630 can have a corresponding output waveguide 640. The waveguide 640 can be the same as, or similar to, the waveguides 140, e.g., fiber optic cables.

The electronic attenuator 635 can be a motorized attenuator where a motor is controlled by the input signal 610 to provide more or less attenuation for a particular waveguide 630. Motorized based attenuation can be a filter wheel, a rotated dielectric mirror apparatus, or a rotated polarization device. The electronic attenuator 635 can be a liquid crystal attenuator that uses crystals to provide various levels of attenuation in various light inputs via the input signal 610, e.g., the electronic attenuator 635 can make crystals more or less absorbent to attenuate the light. The computing system 605 can receive an input vector of size k, or input dataset to execute the network 100 on. The computing system 605 can load the input vector into the network 100 by attenuating each fiber or waveguide 630 on a relative scale, e.g., from 0 to 1. The computing system 605 can transform or encode the input vector into the light input by generating an input signal 610 that controls the electronic attenuator 635 to attenuate light for each input or carried by different waveguides 630.

For example, the computing system 605 can receive an image, such as a grayscale image or color image. For example, the computing system 605 receives a grayscale image, such as a 64 pixel image (although the number of pixels of the image can be much larger) with pixel values between 0-255 for each pixel (although the resolution of each pixel can be much higher). The computing system 205 can normalize each pixel between 0-1, for example, dividing each pixel the maximum pixel value, 255. Each normalized pixel can be loaded into one fiber or waveguide. For example, for a 64 pixel image, the input signal 610 can cause the electronic attenuator 635 to load each normalized value into one of 64 different fibers or waveguides 630. Because each waveguided 630 is shaded from zero to 1 to directly match the relative values of the corresponding pixels, a 1 to 1 correspondence can be achieved between the input vector and the attenuation by the electronic attenuator 635. 64 different fibers or waveguides 630 is exemplary only, and the coupler 625 can output to any number of waveguides 630, e.g., tens, hundreds, thousands.

The outputs of the electronic attenuator 635 can be carried by waveguides 640 (or the waveguides 630) into a first optical layer 645 of axiconal neurons 105. A first optical layer 645 can have a number k of neurons 105. The number of neurons 105 can be the same as the initial fanout by the coupler 625. In this regard, each axicon 110 of the first optical layer 645 can be coupled with one, and only one, waveguide 640 to receive light of one fanout of the coupler 625. In some implementations, two or more waveguides 640 can be coupled with the input of one neuron 105. The network 100 can be a dense network, and therefore, the output of each neuron 105 can be coupled to inputs of each and every axicon 110 in a subsequent optical layer 645. Th network 100 may not be a dense network, e.g., a sparse network, in some implementations. In some implementations, each optical layer 645 is fully connected with subsequent optical layers 645. Each neuron 105 in an optical layer 645 can be pairwise connected with each neuron 105 of a subsequent optical layer 645. In some implementations, the network 100 is not a dense network, or each neuron 105 of each optical layer 645 is not fully connected to neurons 105 of a subsequent layer, e.g., one axicon 110 is connected to one or a number if axiconal neurons 105 that is less than the total number of axiconal neuron 105 in the subsequent optical layer 645. The transmission of light from a neuron 105 to another neuron 105 in the next layer is performed with a waveguide, e.g., the waveguides 140. The neuron 105, however, can perform in free space.

While the first optical layer 645 can include the same number of axiconal neurons 105 as the number of outputs of the coupler 625, the subsequent optical layers 645 can have any number of axiconal neurons 105, more or less than preceding optical layers 645. The number of axiconal neurons 105 can be set based on power consumption, network complexity, and/or physical size of the network 100. While only two optical layers 645 are shown in FIG. 6, any number of layers 645 can be included in the network 100. For example, the optical layers 645 can include a first optical layer 645, a second optical layer 645, a third optical layer 645, etc. Each optical layer 645 can include multiple axiconal neurons 105, that are fully or partially connected between layers 645.

A final optical layer 645 can be coupled with electrical or electronic detectors 650. The network 100 can include a group or set of electronic detectors 650. Each axiconal neuron 105 of the final layer 645 can coupled with at least one electronic detector 650. In some implementations, each axiconal neuron 105 is coupled with one and only one electronic detector 650. For example, a waveguide can couple each axiconal neuron 105 of the final optical layer 645 with one electronic detector 650. For example, the network 100 can include multiple waveguides, one waveguide between each axiconal neuron 105 of the final optical layer 645 and one electronic detector 650.

The electronic detectors 650 can generate the classification signals 615 based on detected, sensed, or measured light. The electronic detectors 650 can generate a classification signal 615 that indicates the classification determined by the optical layers 645 of the network 100. For example, each electronic detector 650 can measure an intensity or amplitude of light received from the final optical layer 645. Each electronic detector 650 can output a voltage signal or digital logic signal indicating the sensed intensity of light. Each electronic detector can be or can include a circuit including a photoresistor, a transistor, a diode, etc. that can sense light. Each electronic detector 650 can be associated with one possible classification of the network 100. For example, for a set of possible classifications, each electronic detector 650 can be associated with one classification of the set of possible classifications. The optical layer 645 can output light of the electronic detectors 650 of a variety of power levels or intensities, the higher the power level or intensity, the greater the probability of one classification. Each electronic detector 650 can correspond to a classification decision. For example, “a yes or no” question, the network 100 can include two detectors 650, one to detect a “yes” classification and the other to detect a “no” classification. For a network 100 that predicts the winner of a sports season, the number of electronic detectors 650 can be equal to the number of competing teams (e.g., one per team). For a large language model, there can be an electronic detector 650 for each output token (e.g., 150,000-200,000 detectors for a chat model).

The computing system 605 can be electrically coupled with the electronic detectors 650, and can receive the classification signal 615 indicating the classification of the network 100. The classification signal 615 can be one or a set of signals, e.g., each individual electronic detector 650 can produce a signal that encodes the power or intensity sensed by the electronic detector 650. The classification signals 615 can be or have a voltage level, frequency, phase, duty cycle, etc. that encodes the power or intensity of light sensed by the electronic detectors 650. In some implementations, the electronic detectors 650 produce one signal classification signal 615 that encodes the sensed power or intensity of each electronic detector 650.

In some implementations, the computing system 605 receives an input vector and a request from an external system, e.g., a medical system, a trading system, a threat detection system, a military system, etc. The input vector received from the medical system can MRI data, x-ray data, blood sample data, urine sample data, etc. The input vector received from the trading system can be a trading history or volume of a stock. The input vector received from the threat detection system or the military system can be an image of a target, a satellite image, radar data, a face of a person, etc. The computing system 605 can receive the input vector via cellular communication, radio communication, network communication, satellite communication, fiber optic communication, etc. Responsive to receiving the input vector, the computing system 605 can operate the electronic attenuator 635 to encode an input signal 610 based on the input vector. The computing system 605 can operate the laser 620 to cause at least one pass of the network 100 to performed with the encoded input vector. The computing system 605 can receive the classification signal 615, determine a classification or a set of highest probability classifications, and respond to the external system with the classification. The classification can be an indication of a disease, a medical condition, a medical state, or a status of a patient. The classification can be an indication to buy or sell a stock. The classification can be an identification of a person, an identification of a threat, an identification of a target, etc.

In some implementations, the computing system 605 can generate a motor control signal 655. The optical layers 645 can include one or multiple motors that move, rotate, or position the optical components of the layers 645. For example, an axiconal neuron 105 can include a motor that switches one material 125 with another material 125. For example, at least one rotary component can be loaded in at least one axiconal neuron 105 with materials 125 of varying thicknesses k. The motor control signal 655 can cause a motor to turn or actuate the rotary component to move a first material 125 out of the path of propagation of light into the axicon 110, and move a second material 125 into the path of propagation of light of the axicon 110. Furthermore, the distances Δ₁ . . . Δₙ can be adjusted by a motor or other actuator. For example, the end 145 can be moved closer or farther away from the ring profile 120. For example, the motor can move the end 145 of the waveguide 140 in a transverse direction to adjust the value of A. The computing system 605 can generate motor control signals 655 to adjust and change the distances Δ₁ . . . Δₙ.

Because the computing system 605 can adjust the thicknesses k of the material 125 by switching out one material 125 with a first thickness k₁ for a second material 125 for a second thickness k₂ (or changing the type of material 125, e.g., changing sapphire to yttrium aluminum garnet) or by adjusting the distances Δ₁ . . . Δₙ, the computing system 605 can configure the optical layers 645 to implement different trained models. For example, the hardware formed by the optical layers 645 can be configured by adjusting the parameters to load in a different model. In this regard, the computing system 605 can receive a request from an external system requesting that a specified model run using a specified input vector. Furthermore, the computing system 605 can, for a given model, re-train the parameters of the model to improve, learn, or adapt over time. In this regard, a single model can be periodically updated with relearned or retrained parameters based on newly received training data.

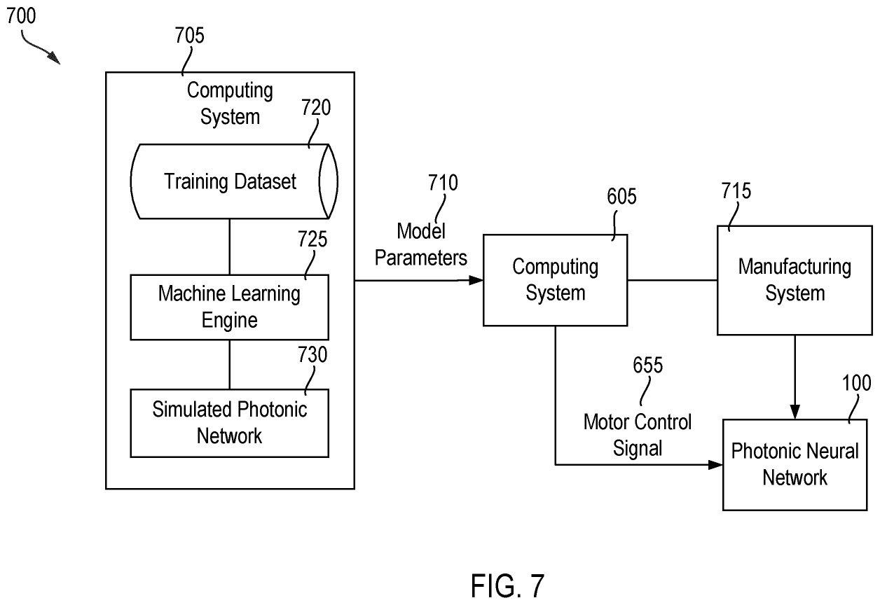

Referring now to FIG. 7, among others, an example system 700 including a computing system 705 to train parameters 710 for a photonic neural network 100 and a manufacturing system 715 to construct the photonic neural network 100 according to the parameters 710. The computing system 705 can include, store, or receive a training dataset 720. The training dataset 720 can include a set of input vectors and corresponding classifications. The computing system 705 can include at least one machine learning engine 725. The computing system 710 can include at least one simulated photonic network 730. The simulated photonic network 730 can be or include mathematical equations that define the propagation of light through one or multiple axiconal neurons 105.

The machine learning engine 725 can execute a machine learning technique using the simulated photonic network 730 and the training dataset 720 to determine model parameters 710. The machine learning engine 725 can determine parameters 710 for each individual neuron 105. The machine learning engine 725 can determine a thickness k of a material 125, a type of the material 125, distances delta Δ₁ . . . Δₙ between the ends 145 of the waveguides 140 and the ring profile 120. The machine learning engine 725 can run multiple epochs of training, implement backpropagation and gradient descent (or stochastic gradient descent, min-batch gradient descent, Newton's Method, Quasi-Netwon's method, conjugate gradient method etc.), or any other training technique to learn values for the parameters 710 of the neurons 105. The machine learning technique can perform training using real numbers, R. Because the training can adjust k and delta values Δ₁ . . . Δₙ to simulate linear and non-linear relationships of power and intensity in the simulated photonic network 730, but not phase, the training can be performed on only real numbers, R, and not imaginary numbers, i. In some implementations, the training can take into account phase, and training can be performed with real and imaginary numbers.

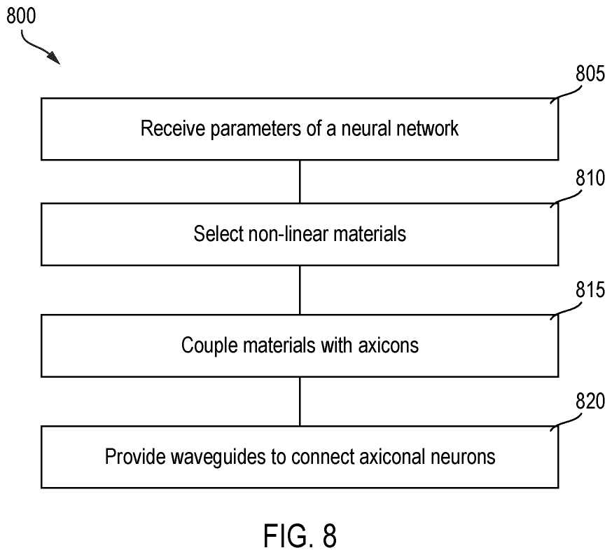

Referring now to FIG. 8, among others, an example method 800 of constructing a photonic neural network 100 according to trained parameters 710 is shown. The method 800 can include am ACT 805 of receiving parameters of a neural network. The method 800 can include an ACT 810 of selecting non-linear materials. The method 800 can include an ACT 815 of coupling materials with axicons. The method 800 can include an ACT 820 of providing waveguides to connect axiconal neurons. The computing system 705, the computing system 605, the manufacturing system 715, or the photonic neural network 100 can implement at least a portion of the method 800.

At ACT 805, the method 800 can include receiving, by the computing system 605, model parameters 710 of a neural network. The model parameters 710 can identify the number of axiconal neurons 105 for the photonic neural network 100. The model parameters 710 can identify the interconnections between the axiconal neurons 105. For example, the model parameters 710 can identify that a first axiconal neuron 105 of a first optical layer 645 should output light to a second axiconal neuron 105 of a second subsequent optical layer 645. The model parameters 710 can identify that a first axiconal neuron 105 of a first optical layer 645 should not output light to a second axiconal neuron 105 of a second subsequent optical layer 645. The model parameters 710 can include a value (e.g., a length or measurement) of the thickness k for the material 125 for at least a portion of the axiconal neurons 105. The model parameters 710 can indicate that an axiconal neuron 105 should include the material 125, or should not include the material 125. The model parameters 710 can include a value (e.g., a length or measurement) of the distances Δ₁ . . . Δₙ between inputs 145 of waveguides 140 and a ring profile 120 for at least a portion of the axiconal neurons 105.

The method 800 can include receiving the model parameters 710 from a computing system 705, e.g., a machine learning engine 725. The method 800 can include generating the model parameters 710 by the computing system 705, the computing system 605, or the manufacturing system 715. The method 800 can include executing the machine learning engine 725 to train the model parameters 710 of a simulated photonic network 730.

At ACT 810, the method 800 can include selecting non-linear materials 125. The method 800 can include selecting a material 125 for each neuron 105 of the network 100. For example, the method 800 can select each non-linear material 125 using at least one of the parameters 710. The method 800 can include selecting different types of material 125. The method 800 can include selecting materials 125 with different thicknesses k according to the parameters 710. The method 800 can include generating a parts list, retrieving materials 125 that have corresponding thicknesses k, machining or manufacturing materials 125 to have thicknesses k, etc.

At ACT 815, the method 800 can include coupling materials 125 with axicons 110. The method 800 can include coupling one selected material 125 with one axicon 110 to form each axiconal neuron 105. The method 800 can include identifying which material 125 of which thickness k to use in each axicon 110 based on the location or connections of the particular axiconal neuron 105. The method 800 can include coupling the materials 125 with the axicons 110 by placing the material 125 in front of or at the aperture or input of the axicon 110 or against the aperture or input of the axicon 110. Coupling the materials 125 with the axicons 110 can include fixing the material 125 and the axicon 110 in locations or positions where light will be output from the material 125 into the axicon 110. The coupled material 125 and the axicon 110 can be separated by free space, or can be in physical contact.

At ACT 820, the method 800 can include providing waveguides 140 to connect axiconal neurons 105 of the photonic neural network 100. The method 800 can include positioning the waveguides 140 using the model parameters 710. For example, the method 800 can include positioning ends 145 of the waveguides distances Δ₁ . . . Δₙ from the ring profile 120 in a transverse direction (e.g., perpendicular to a direction of propagation through the network 100 or perpendicular to a direction of propagation of light through the axicon 110. For a particular axiconal neuron 105, the method 800 can include providing a number of waveguides 140 equal to the number of axiconal neurons 105 that the particular axiconal neuron 105 connects to. The method 800 can include positioning an end 145 of a waveguide 140 a distance Δ from a ring profile 120 of one axiconal neuron 105, and disposing the opposite end of the waveguide 140 in a coupler 130 of a subsequent axiconal neuron 105 of the network 100.

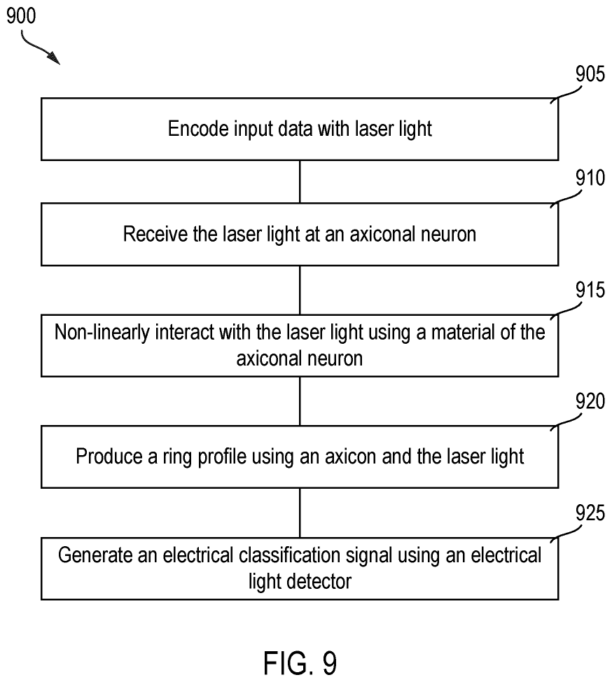

Referring now to FIG. 9, among others, an example method 900 of executing a photonic neural network 100 is shown. The method 900 can include an ACT 905 of encoding input data with laser light. The method 900 can include an ACT 910 of receiving the laser light at an axiconal neuron. The method 900 non-linearly interacting with the laser light using a material of the axiconal neuron. The method 900 can include producing a ring profile using an axicon and the laser light. The method 900 can include generating an electrical classification signal using an electrical light detector. The computing system 705, the computing system 605, the manufacturing system 715, or the photonic neural network 100 can implement at least a portion of the method 900.

At ACT 905, the method 900 can include encoding input data with laser light. The method 900 can include activating 620. For example, the computing system 605 can cause the laser 620 to activate to produce laser light. For example, the computing system 605 can cause the laser 620 to produce laser light and provide the laser light to a coupler 625. The method 900 can include fanning the laser light of the laser 620 into multiple waveguides 630. The waveguides 630 can correspond to inputs of an input vector. The method 900 can include attenuating the light carried by each waveguide 630. The method can include generating an input signal 610 to control an electronic attenuator 635 to provide an amount of attenuation in each waveguide 630 to encode the input vector in the laser light carried by the waveguides 630.

At ACT 910, the method 900 can include receiving the laser light at an axiconal neuron 105. At least one axiconal neuron 105 can receive the laser light produced by the laser 620 at an input of the axiconal neuron 105. For example, an axiconal neuron 105 can receive attenuated light (or light selectively not attenuated) from the electronic attenuator 635. Each axiconal neuron 105 of a first optical layer 645 of axiconal neurons 105 can receive light from one waveguide 630 of the waveguides 630.

At ACT 915, the method 900 can include non-linearly interacting with the laser light using a material 125 of the axiconal neuron 105. The axiconal neuron 105 can include a material 125 that non-linearly interacts with light. The material 125 can be fused silica, sapphire, yttrium aluminum garnet, yttrium vanadate, etc. The material 125 can have a non-linear relationship between light intensity input at the material and the refractive index of the material. The material 125 can have a non-linear index of at least 2.00 10⁻²⁰ m²/W. The material 125 can provide second or third order non-linear polarization of light.

At ACT 920, the method 900 can include producing a ring profile 120 using an axicon 110 and the laser light. The method 900 can include receiving the laser light output by the material 125, and outputting the laser light through an output or face of the axicon 110. The output laser light can form a Bessel beam, and a ring profile 120 outside a particular region. The ring profile 120 can have a greatest intensity in a middle band of the ring profile 120. The method 900 can include guiding light from the ring profile 120 to at least one (or multiple) different axiconal neurons 105. Light from multiple outputs of multiple axiconal neurons 105 of an optical layer 645 can be guided to a coupler 130 of another axiconal neuron 105, which can combine the light of the multiple axiconal neurons 105, and provide the combined light to the material 125 and axicon 110 of the axiconal neuron 105.

At ACT 925, the method 900 can include generating an electrical classification signal using an electrical light detector. For example, the method 900 can include processing the laser light through multiple optical layers 645 of the photonic neural network 100. A final or last layer 645 of the network 100 can output to electronic detectors 650. Each axiconal neuron 105 of the final layer 645 can be coupled with one electronic detector 650. Each electronic detector 650 can measure laser light power or laser light intensity received from the axicon 110. The greater the power or intensity measured by an electronic detector 650, the higher the probability of classification to a particular class associated with the electronic detector 650. Each electronic detector 650 can be associated with or be linked to a particular class of a set of classes. The electronic detectors 650 can output a classification signal 615 which indicates the probability that a given input encoded via the input signal 610 and the electronic attenuator 635 belongs to each class of the set of classes.

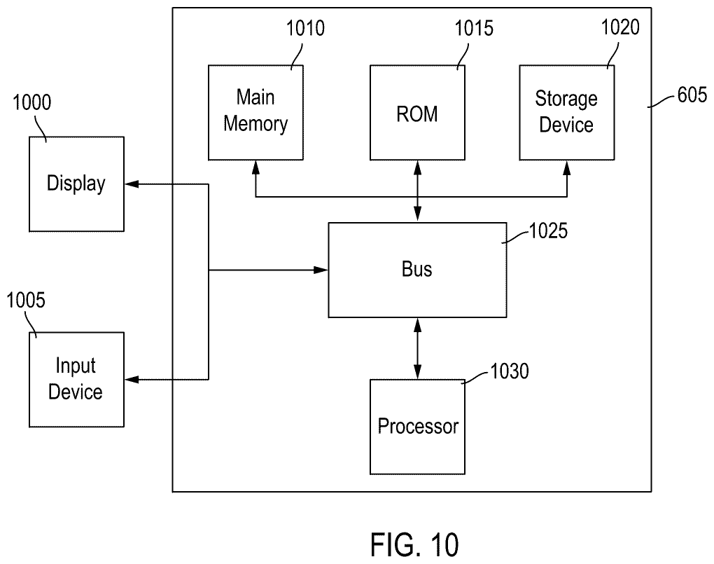

Referring now to FIG. 10, among others, is an example computing architecture of a computing system 605 is shown. The computing system 605 can include or be used to implement a data processing system or its components. The computing architecture of FIG. 10 can be used to implement at least a portion of the computing system 705, the computing system 605, or the manufacturing system 715. The computing system 605 can include at least one bus 1025 or other communication component for communicating information and at least one processor 1030 or processing circuit coupled to the bus 1025 for processing information. The computing system 605 can include one or more processors 1130 or processing circuits coupled to the bus 1025 for processing information. The computing system 605 can include at least one main memory 1010, such as a random access memory (RAM) or other dynamic storage device, coupled to the bus 1025 for storing information, and instructions to be executed by the processor 1030. The main memory 1010 can be used for storing information during execution of instructions by the processor 1030. The computing system 605 can further include at least one read only memory (ROM) 1015 or other static storage device coupled to the bus 1025 for storing static information and instructions for the processor 1030. A storage device 1020, such as a solid state device, magnetic disk or optical disk, can be coupled to the bus 1025 to persistently store information and instructions.

The computing system 605 can be coupled via the bus 1025 to a display 1000, such as a liquid crystal display, or active matrix display. The display 1000 can display information to a user. An input device 1005, such as a keyboard or voice interface can be coupled to the bus 1025 for communicating information and commands to the processor 1030. The input device 1005 can include a touch screen of the display 1000. The input device 1005 can include a cursor control, such as a mouse, a trackball, or cursor direction keys, for communicating direction information and command selections to the processor 1030 and for controlling cursor movement on the display 1000.

The processes, systems and methods described herein can be implemented by the computing system 605 in response to the processor 1030 executing an arrangement of instructions contained in main memory 1010. Such instructions can be read into main memory 1010 from another computer-readable medium, such as the storage device 1020. Execution of the arrangement of instructions contained in main memory 1010 causes the computing system 605 to perform the illustrative processes described herein. One or more processors in a multi-processing arrangement can be employed to execute the instructions contained in main memory 1010. Hard-wired circuitry can be used in place of or in combination with software instructions together with the systems and methods described herein. Systems and methods described herein are not limited to any specific combination of hardware circuitry and software.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. “Coupling” or “coupled” can refer to the arrangement of two or more optical components at or near one another to propagate light from one component to the other. Two or more coupled optical components can include surfaces adhered or fixed to one another or separated by free space.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Various types optical hardware, apparatuses, devices, or components (e.g., lenses, waveguides, polarizers, collimators, light sources, or lasers) can be used to implement the various optical systems, apparatus, or equipment described herein, and the optical components can be varied or interchanged. The order of optical components in a path of light propagation can be switched or rearranged. The dimensions or defining angles of optical components can be varied or configured to focus or direct light in a particular direction, create light with a desired profile, or polarize light with a desired polarization.

“Reflect” or “reflection” can refer to the phenomena where at least a portion of an incident wave is not absorbed by a new medium at a boundary between two medium, but is returned at a zero or non-zero angle relative to the incident ray. “Refraction” can refer to the phenomena where an incident light wave traveling in a first medium changes direction at a boundary with a second medium. Refractive indices of mediums can refer to the quantification the amount of the redirection that mediums provides. “Waveguides” can refer to any component or medium to restrict the transmission of energy in a desired direction, such as an optical waveguide. Optical waveguides can be or include any optical component, material, or liquid to guide light by restricting the propagation of light in a spatial region or in a particular direction. Waveguides can be planar waveguides (e.g., slab waveguides), two-dimensional waveguides (e.g., rectangular waveguides), light pipes, light tubes, or optical fibers. Waveguides can include materials of varied refractive indices to guide light in a desired direction or within a desired region. For example, waveguides can include a core and cladding at least partially surrounding the core. Waveguides can propagate light via total internal reflection.

“Free space” can refer to an area or distance free of optical hardware. Free space can include a region or area that is a vacuum or at least partially filled with at least one gas or liquid that has no or minimal lensing, reflective, or refractive characteristics. “Light” can refer to natural or artificial light, such as laser light. Light can refer to visible or non-visible light in a variety of wavelength ranges, e.g., gamma rays, x-rays, ultraviolet, visible spectrum, infrared, etc. “Polarized light” or “polarization” can refer to the geometric orientation of transverse electro-magnetic oscillations. “Collimated light” can refer to light waves substantially parallel with one another, light waves with no meaningful angle of difference between one another, or light produced by a collimator or similar device. “Gaussian beam” can refer to a profile of light with electromagnetic radiation in a transverse plane defined by a Gaussian function. “Interference” can refer to the construction or destruction of multiple interacting waves in a medium.

The electrical hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the [apparatus, system, assembly, etc.] as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A photonic neural network apparatus, comprising:
a plurality of interconnected axiconal neurons to produce a classification using laser light, a first axiconal neuron of the plurality of interconnected axiconal neurons, comprising:
a material to non-linearly interact with the laser light, the material comprising a thickness determined with a machine learning technique; and
an axicon to receive the laser light from the material and produce a ring profile; and
a waveguide positioned at the ring profile to guide the laser light of the ring profile to a second axiconal neuron of the plurality of interconnected axiconal neurons.

2. The photonic neural network apparatus of claim 1, comprising:
the plurality of interconnected axiconal neurons, each comprising:
a material to non-linearly interact with the laser light, the material of each of the plurality of interconnected axiconal neurons comprising a thickness determined with the machine learning technique to provide an attention mechanism.

3. The photonic neural network apparatus of claim 1, comprising:
the material to non-linearly interact with the laser light to cause the axicon to generate the ring profile comprising a thickness between an inner and outer radius of the ring profile, the thickness non-linearly related to an intensity of the laser light received by the material.

4. The photonic neural network apparatus of claim 1, comprising:
the waveguide comprising an input positioned a distance in a transverse direction from the ring profile, the distance determined with the machine learning technique.

5. The photonic neural network apparatus of claim 1, comprising:
a first layer of axiconal neurons of the plurality of interconnected axiconal neurons, the first layer of axiconal neurons comprising the first axiconal neuron;
a second layer of axiconal neurons of the plurality of interconnected axiconal neurons; and
a plurality of waveguides positioned at the ring profile of the first axiconal neuron to guide the laser light to an input of each of the plurality of interconnected axiconal neurons of the second layer of axiconal neurons to form a dense network.

6. The photonic neural network apparatus of claim 1, wherein:
the thickness of the material for the first axiconal neuron is determined with the machine learning technique using real numbers and not imaginary numbers.

7. The photonic neural network apparatus of claim 1, comprising;
a coupler to:
receive the laser light output from at least two of the plurality of interconnected axiconal neurons;
combine the laser light output from the at least two of the plurality of interconnected axiconal neurons; and
provide the combined laser light to an input of the first axiconal neuron.

8. The photonic neural network apparatus of claim 1, comprising:
a pulsed laser to generate the laser light, the pulsed laser having a power level on an order of gigawatts or higher;
a coupler to receive the laser light from the pulsed laser and fan the laser light into a plurality of waveguides; and
an electrical attenuator to attenuate the laser light guided by at least some of the plurality of waveguides to encode input data with the laser light for the plurality of interconnected axiconal neurons to generate the classification with.

9. The photonic neural network apparatus of claim 1, comprising:
a final layer of axiconal neurons of the plurality of interconnected axiconal neurons;
a plurality of waveguides to connect each axiconal neuron of the final layer of axiconal neurons with one electrical detector of a set of electrical detectors; and
the set of electrical detectors to generate an electrical signal to indicate the classification.

10. The photonic neural network apparatus of claim 1, comprising:
a motor to switch the material with a second material, the motor to move the material out of a path of propagation of the laser light and move the second material into the path of propagation of the laser light,
the second material to non-linearly interact with the laser light, the second material comprising a second thickness different than the first thickness.

11. The photonic neural network apparatus of claim 1, comprising:
a motor to move the waveguide to vary a distance in the transverse direction between an input of the waveguide and the ring profile.

12. A method, comprising:
receiving a plurality of parameters of a neural network trained with a machine learning technique;
selecting, using the plurality of parameters, a plurality of materials to non-linearly interact with laser light, the plurality of materials comprising different thicknesses;
coupling the plurality of materials with a plurality of axicons to form a plurality of axiconal neurons, the plurality of axicons to receive the laser light from respective materials of the plurality of materials and produce ring profiles; and
providing a plurality of waveguides to guide the laser light from ring profiles of first axiconal neurons of the plurality of axiconal neurons to inputs of second axiconal neurons of the plurality of axiconal neurons.

13. The method of claim 12, comprising:
determining, by a computing system, the different thicknesses with the machine learning technique to provide an attention mechanism for the plurality of axiconal neurons.

14. The method of claim 12, comprising:
positioning, using the plurality of parameters, inputs of the plurality of waveguides different distances in a transverse direction from the ring profiles.

15. The method of claim 12, comprising:
receiving an electrical signal indicating input data;
operating a pulsed laser to generate the laser light at a power level on an order of gigawatts or higher;
receiving, by a coupler, the laser light from the pulsed laser;
fanning, by the coupler, the laser light into a plurality of particular waveguides; and
attenuating, using an electrical attenuator and the electrical signal, the laser light guided by at least some of the plurality of particular waveguides to encode the input data.

16. The method of claim 12, comprising:
detecting, using a set of electrical detectors, an intensity of the laser light output by a final layer of the plurality of axiconal neurons; and
generating, using the set of electrical detectors, an electrical signal indicating a classification.

17. The method of claim 12, comprising:
operating a motor to switch a first material with a second material, the motor to move the first material out of a path of propagation of the laser light and move the second material into the path of propagation of the laser light,
the second material to non-linearly interact with the laser light, the second material comprising a second thickness different than a first thickness of the first material.

18. The method of claim 12, comprising:
operating a motor to move a waveguide in a traverse direction to vary a distance in the transverse direction between an input of the waveguide and a ring profile.

19. An axiconal neuron apparatus, comprising:
a material to non-linearly interact with laser light, the material comprising a thickness determined with a machine learning technique; and
an axicon to receive the laser light from the material and produce a ring profile;
the axicon to provide the ring profile to a waveguide to guide the laser light of the ring profile to another axiconal neuron apparatus.

20. The axiconal neuron apparatus of claim 19, comprising:
the material to non-linearly interact with the laser light to cause the axicon to generate the ring profile comprising a thickness between an inner and outer radius of the ring profile, the thickness non-linearly related to an intensity of the laser light received by the material.
